(19) United States
(12) Patent Application Publication
(10) Pub. No.: US 2007/0051212 A1
(43) Pub. Date: Mar. 8, 2007

(54) Ergonomic driving tool

(76) Inventor: Chih-Ching Hsieh, Taichung (TW)

Correspondence Address: Chih-Ching Hsieh, 235 Chung-Ho, Box 8-24, Taipei, TW

(21) Appl. No.: 11/220,198

(22) Filed: Sep. 6, 2005

(51) Int. Cl. B25B 23/16; B25G 1/00

(52) U.S. Cl. 81/177.7; 81/177.8

(57) ABSTRACT

An ergonomic driving tool comprises a handle; one end of the handle having a pivotal portion; another end of the handle being formed with a clamping portion; the clamping portion having a notch; a driving head pivotaiiy installed to the pivotal portion. A handle length of the handle is defined as a length from a middle portion of the pivotal portion to a bottom of the handle; the driving head length is from the middle section of the pivotal portion to a top of the driving head; the handle length is 2.2 to 2.7 times of the driving head length. A driving head diameter of the driving head is defined as a distance between two lateral sides of the driving head. A clamping portion diameter is distance as length between two lateral sides of the clamping portion; and the driving head diameter is 0.8 to 1.2 times of the clamping portion diameter.

### FIELD OF THE INVENTION

The present invention relates to driving tools, and in particular to an ergonomic driving tool, wherein the driving head pivoted to the handle can be adjusted to a required orientation so as to suit the work environment. In general working field, the user can operate by holding the handle by hands.

### BACKGROUND OF THE INVENTION

In the prior art, the spanner has a body. At least one end of the spanner has an opened spanner portion which is installed with a head and a clamping portion. This kind of prior art spanner is not suitable for being held. When the user holds the handle of the spanner for driving a screw, the spanner must be placed to a position for clamping the screw.

If the working space is very narrow, it is very difficult to operate the spanner easily and comfortably. If the design of the spanner is not an ergonomic design, the worker will feel uneasy and the working efficiency is low. Thereby there is an eager demand for a novel design which is suitable for the requirement of ergonomics so that the user can hold the working tool comfortable and easily.

### SUMMARY OF THE INVENTION

Accordingly, the primary object of the present invention is to provide an ergonomic driving tool, wherein the driving head pivoted to the handle can be adjusted to a required orientation so as to suit the work environment. In general working field, the user can operate by holding the handle by hands.

To achieve above objects, the present invention provides an ergonomic driving tool which comprises a handle; one end of the handle having a pivotal portion; another end of the handle being formed with a clamping portion; the clamping portion having a notch; a driving head pivotally installed to the pivotal portion. A handle length of the handle is defined as a length from a middle portion of the pivotal portion to a bottom of the handle; the driving head length is from the middle section of the pivotal portion to a top of the driving head; the handle length is 2.2 to 2.7 times of the driving head length. A driving head diameter of the driving head is defined as a distance between two lateral sides of the driving head. A clamping portion diameter is distance as length between two lateral sides of the clamping portion; the driving head diameter is 0.8 to 1.2 times of the clamping portion diameter.

The various objects and advantages of the present invention will be more readily understood from the following detailed description when read in conjunction with the appended drawing.

### BRIEF DESCRIPTION OF THE DRAWINGS

FIG. 1 is a structural schematic view about the ergonomic driving tool of the present invention.

FIG. 2 is a schematic perspective view of the ergonomic driving tool of the present invention.

FIG. 3 is a schematic view showing the operation of the present invention.

FIG. 4 is a schematic view showing the extension of the arm of force of the ergonomic driving tool of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

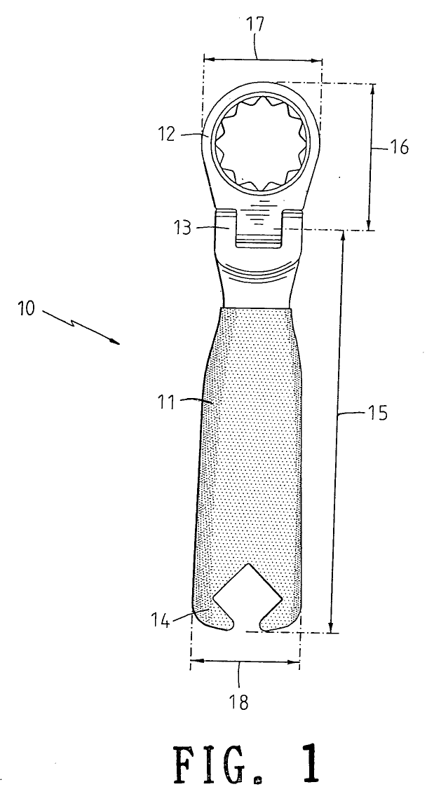

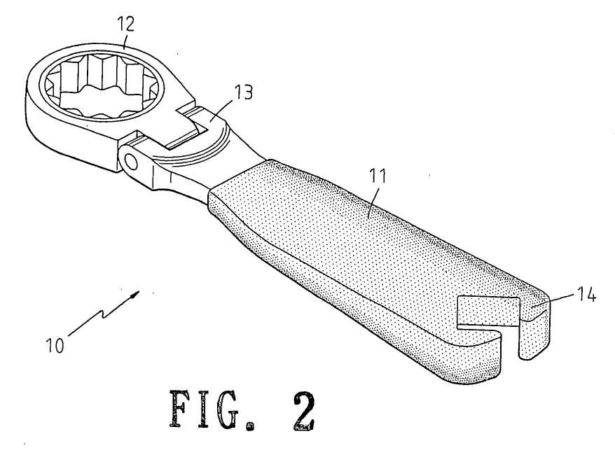

With reference to FIG. 1 to 2, the tool body 10 of the present invention will be described in the following.

The present invention has a tool body 10 which is made of light metal (such as aluminum).

A handle 11 is made of light metal, such as aluminum. One end of the handle 11 has a pivotal portion 13. Another end of the handle 11 is formed with a clamping portion 14. The clamping portion 14 has a notch. The notch has for example a rectangular shape.

A driving head 12 is pivotally installed to the pivotal portion 13 so that the driving head 12 is adjustable to different orientations by rotating around the pivotal portion 13.

Referring to FIG. 1, a length 15 of the handle 11 is defined as a length from a middle portion of the pivotal portion 13 to a bottom of the handle 11. The driving head length 16 is from the middle section of the pivotal portion 13 to a top of the driving head 12. The handle length 15 is 2.2 to 2.7 times of the driving head length 16. A driving head diameter 17 of the driving head 12 is defined as a distance between two lateral sides of the driving head 12, see FIG. 1. A clamping portion diameter 18 is a distance between two lateral sides of the clamping portion 14. The driving head diameter 17 is 0.8 to 1.2 times of the driving head diameter 17. Above mentioned ratios are most suitable ratios in operation and for the requirement of ergonomics.

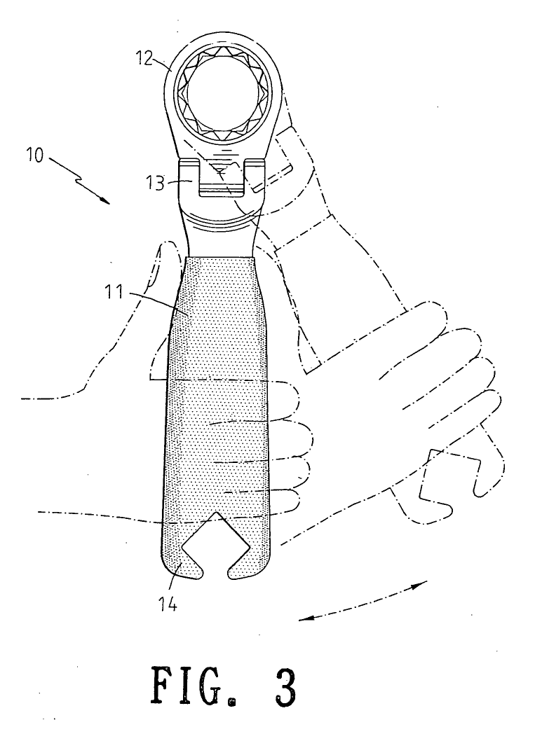

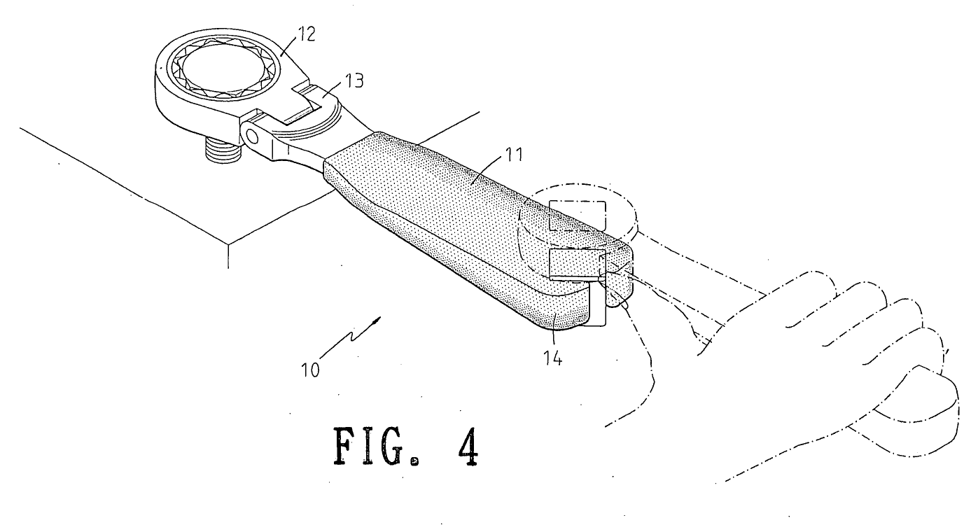

Referring to FIGS. 3 and 4, the use of the spanner is that the driving head 12 pivoted to the handle 11 can be adjusted to a required orientation so as to suit the work environment. In general working field, the user can operate by holding the handle 11 by hands. If a longer arm of force is needed, another spanner can be engaged to the clamping portion 14 for prolong the length of the working tool.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An ergonomic driving tool comprising:
a handle; one end of the handle having a pivotal portion; another end of the handle being formed with a clamping portion; the clamping portion having a rectangular notch; one corner of the rectangular notch is opened at an end portion of the handle 11 far away from the end to a driving head;
the driving head pivotally installed to the pivotal portion;
wherein a handle length of the handle is defined as a length from a middle portion of the pivotal portion to a bottom of the handle; the driving head length is defined a length from the middle section of the pivotal portion to a top of the driving head; the handle length is 2.2 to 2.7 times the driving head length; a driving head diameter of the driving head being defined as a distance between two lateral sides of the driving head; a clamping portion width is defined as length between two lateral sides of the clamping portion; the driving head diameter is 0.8 to 1.2 times the clamping portion diameter;
wherein the handle is reduced at another end near the driving head and the pivotal portion is reduced at one end near the handle portion so that the connection of the handle and the pivotal portion is a minimum section, and thus a user can press the connection by a thumb so as to operate the driving tool easily and the work can be performed effectively.

2. The ergonomic driving tool as claimed in claim 1, wherein a handle is made of light metal.

3. The ergonomic driving tool as claimed in claim 2, wherein the light metal is aluminum.

4. The ergonomic driving tool as claimed in claim 1, wherein the pivotal portion is pivoted to different hand tools.

5. The ergonomic driving tool as claimed in claim 1, wherein the notch has a rectangular shape.

6. The ergonomic driving tool as claimed in claim 1, wherein the notch is capable of being engaged to a tool for prolonging a length of the ergonomic driving tool.
